(19) United States
(12) Patent Application Publication
(10) Pub. No.: US 2005/0271776 A1
(43) Pub. Date: Dec. 8, 2005

(54) Edible food container

(76) Inventor: William Siegel, Palmetto Bay, FL (US)

Correspondence Address: HARNESS, DICKEY & PIERCE, P.L.C., P.O. BOX 828, BLOOMFIELD HILLS, MI, 48303, US

(21) Appl. No.: 10/860,618

(22) Filed: Jun. 3, 2004

(51) Int. Cl. A21D 13/00

(52) U.S. Cl. 426/138

(57) ABSTRACT

An edible food container is provided including a first edible side, a second edible side, and a first quantity of an edible adhesive. The edible adhesive is disposed between and sealingly attaches the first and second edible sides.

### FIELD OF THE INVENTION

The present invention relates to food containers and, more particularly, to edible food containers having low carbohydrate content.

### BACKGROUND OF THE INVENTION

The latest dieting craze includes a low carbohydrate diet. Dieters following this diet often refrain from eating such things as bread, pasta, potatoes, and rice. This means that a hamburger or hot dog must each be eaten without a bun, which can make for a messy experience. The simple solution is to eat these meals with a knife and fork. However, a knife and fork or plate may not always be available to the consumer, particularly when the consumer is driving or walking. Driving or walking consumers must be able to eat with their hands. One solution has been to wrap the hamburger or hot dog in a paper wrapping or a vegetable leaf. This approach provides something for the consumer to grasp and some amount of protection from the juices and/or condiments ubiquitous to a cheeseburger or a hot dog, but fails to provide absolute protection. A piece of wrapping paper or a vegetable leaf must be folded around the meal. This creates seams in the wrapper, which makes the wrapper vulnerable to leaking juices and/or condiments. These juices and/or condiments ultimately escape onto the consumer's hands, clothing, and/or vehicle upholstery.

### SUMMARY OF THE INVENTION

An edible food container is provided including a first edible member, a second edible member, and a first quantity of an edible adhesive. The edible adhesive is disposed between and sealingly attaches the first and second edible members.

Another aspect of the present invention provides an edible food container including a first edible member, a second edible member, and a first quantity of edible adhesive. The first edible member includes a storage face and a handling face. The second edible member includes a storage face and a handling face. A portion of the handling face of the second member is disposed adjacent a portion of the storage face of the first member. The first quantity of an edible adhesive is disposed between and sealingly attaching the first and second members.

A yet further aspect of the present invention provides a method of manufacturing an edible food container. Initially, a first edible member is selected. The first edible member includes a storage face and a handling face. Next, a second edible member is selected. The second edible member includes a storage face and a handling face. Then, a first quantity of an edible adhesive is applied to a portion of at least one of the handling face of the second member and the storage face of the first member. Finally, the first and second members are attached via the first quantity of the adhesive.

A yet further aspect of the present invention provides an edible food container including an edible member and an edible substance. The edible substance substantially coats the edible member to retain the edible member in a predetermined shape.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an edible food container in accordance with the principles of the present invention;

FIG. 2 is an exploded perspective view of the edible food container of FIG. 1;

FIG. 3 is an exploded perspective view of a first alternative embodiment of the edible food container of FIG. 1;

FIG. 4 is a perspective view of a second alternative embodiment of the edible food container of FIG. 1; and

FIG. 5 is a perspective view of a third alternative embodiment of the edible food container of FIG. 1.

### DETAILED DESCRIPTION OF THE PREFERRED EMBODIMENTS

The following description of the preferred embodiments is merely exemplary in nature and is in no way intended to limit the scope of the invention, its application, or its uses.

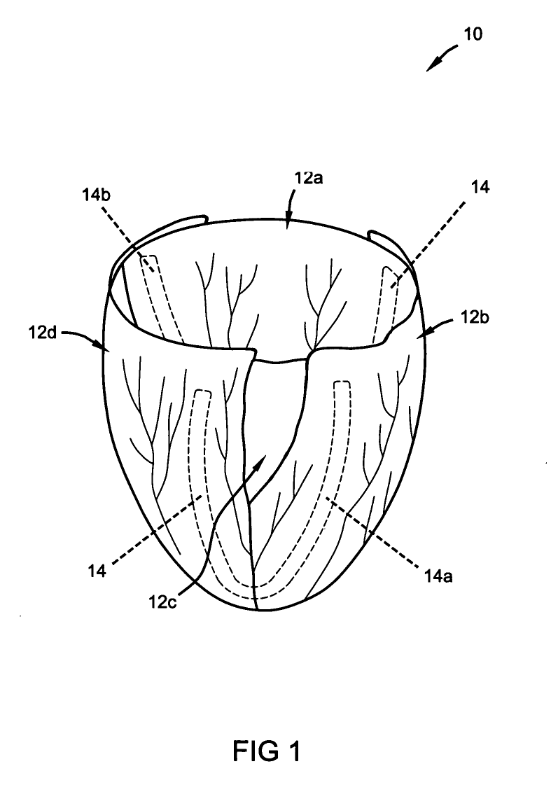

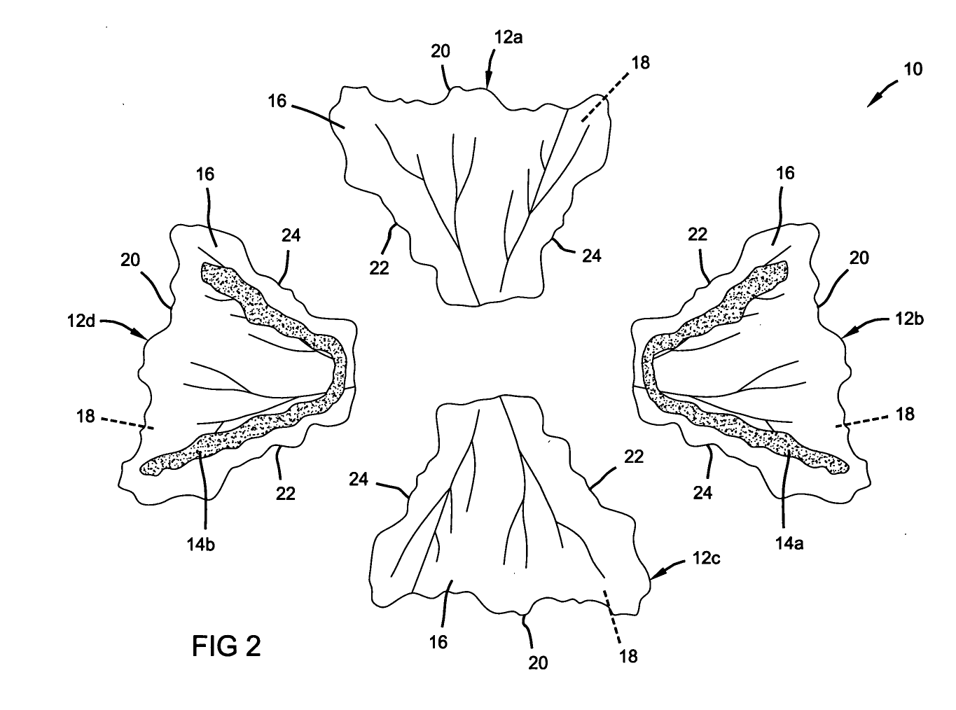

With reference to FIGS. 1 and 2, an edible food container 10 in accordance with the principles of the present invention generally includes a plurality of edible members 12 and an edible adhesive 14. The members 12 are sealingly adhered together via the adhesive 14 to create a cup-shaped envelope. The container 10 is adapted to contain a meal such as a hamburger, as well as any desired condiments and/or toppings. It should be appreciated that the geometry of the container 10, as shown FIG. 1, is merely exemplary and that alternative geometries are intended to be within the scope of the present invention. For example, it is envisioned that the container 10 would be constructed as an elongated tub, resembling a canoe, to contain a hot dog.

The plurality of members 12 includes four members 12a-12d. It should be appreciated, however, that any number of members 12 could be utilized to construct a container 10 in accordance with the principles of the present invention. In an exemplary embodiment, the members 12 have a low carbohydrate content such as lettuce leaves. It is envisioned that in an alternative embodiment, the members 12 could include cabbage leaves, spinach leaves, or any other edible member, natural or synthetic, capable of serving the principles of the present invention. It should also be appreciated that a combination of different members could be used to form a single container 10. For example, members 12a and 12c could be red cabbage leaves and members 12b and 12d could be spinach leaves. Each of the members 12 include a storage face 16, a handling face 18, a first edge 20, a second edge 22, and a third edge 24.

The edible adhesive 14 includes a first quantity of edible adhesive 14a and a second quantity of edible adhesive 14b. It is envisioned that the edible adhesive 14 may include a sugar-based or gelatin-based adhesive. It should be appreciated that a sugar-based adhesive includes carbohydrates. Nevertheless, if the sugar-based adhesive is made with a sugar having a low glycemic index and used sparingly, carbohydrate intake and storage within the body will be minimal. Furthermore, it should be appreciated that while only sugar-based and gelatin-based edible adhesives have been disclosed herein, any edible adhesive is intended to be within the scope of the present invention.

The first quantity of edible adhesive 14a is disposed between and sealingly engages the storage face 16 of member 12b and the handling faces 18 of members 12a and 12c. The first quantity of edible adhesive 14a is disposed generally adjacent the second edge 22 and third edge 24 of member 12b, the third edge 24 of member 12a, and the second edge 22 of member 12c. The second quantity of edible adhesive 14b is disposed between and sealingly engages the storage face 16 of member 12d and the handling faces 18 of members 12a and 12c. The second quantity of edible adhesive 14b is disposed generally adjacent the second edge 22 and third edge 24 of member 12d, the second edge 22 of member 12a, and the third edge 24 of member 12c. It should be understood that the above-described configuration is merely exemplary and that alternative configurations providing similar results are intended to be within the scope of the present invention. For example, the arrangement of the members 12, as well as the location of the adhesive 14, may be varied. Furthermore, while it has been disclosed herein that the adhesive 14 is disposed adjacent to the edges of the members 12, thereby requiring overlapping members 12, the adhesive 14 may alternatively be applied directly to the edges of the members 12. In such an embodiment, the handling faces 18 of members 12a and 12c would not overlap the storage faces 16 of members 12b and 12d. Rather, the third edge 24 of member 12a would abut and adhere to the second edge 22 of member 12b. The second edge 22 of member 12a would abut and adhere to the third edge 24 of member 12d. The second 22 edge of member 12c would abut and adhere to the third edge 24 of member 12b. The third edge of leaf 12c would abut and adhere to the second edge 22 of member 12d.

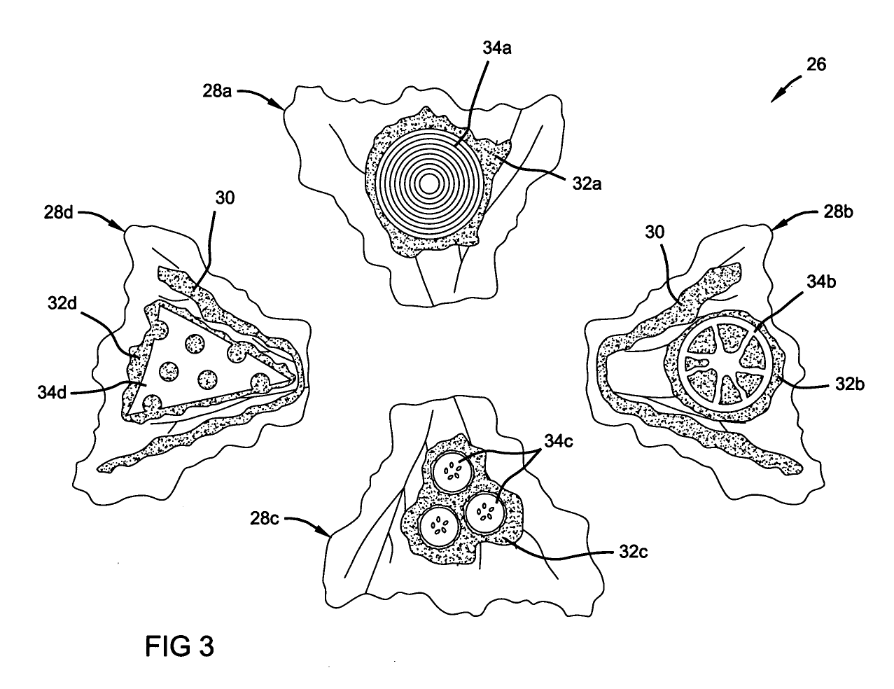

FIG. 3 depicts an alternative embodiment of an edible food container 26. The edible food container 26 includes a plurality of members 28, a first edible adhesive 30, a second edible adhesive 32, and a plurality of insulators 34. The plurality of members 28 and the first edible adhesive 30 are identical to that described above in accordance with the first embodiment. The plurality of insulators 34 include an onion slice 34a, a tomato slice 34b, a plurality of pickle slices 34c, and a slice of cheese 34d. The second edible adhesive 32 includes a first quantity 32a, a second quantity 32b, a third quantity 32c, and a fourth quantity 32d. The first quantity of edible adhesive 32a is disposed between and adheres the onion slice 34a to member 28a. The second quantity of edible adhesive 32b is disposed between and adheres the tomato slice 34b to member 28b. The third quantity of edible adhesive 32c is disposed between and adheres the pickle slices 34c to member 28c. The fourth quantity of edible adhesive 32d is disposed between and adheres the cheese slice 34d to member 28d. The insulators 34 provide a thermal barrier between a meal (not shown) contained in the container 26 and the consumer.

The meal, which may include a freshly cooked hamburger, hot dog, or similar substance, may be hot when served to a consumer. Thus, the plurality of insulators 34 decrease the thermal conductivity of the container 26. In an alternative embodiment, each of the plurality of insulators 34 include one or more members identical to the members 28 described above. Furthermore, while the container 26 is disclosed as having an insulator 34 adhered to all of its four members 28, it should be appreciated that a container 26 having an insulator 34 adhered to less than all of its members 28 is intended to be within the scope of the present invention. Lastly, it should be appreciated that any edible matter capable of decreasing the thermal conductivity of the container 26 may be used as an insulator 34.

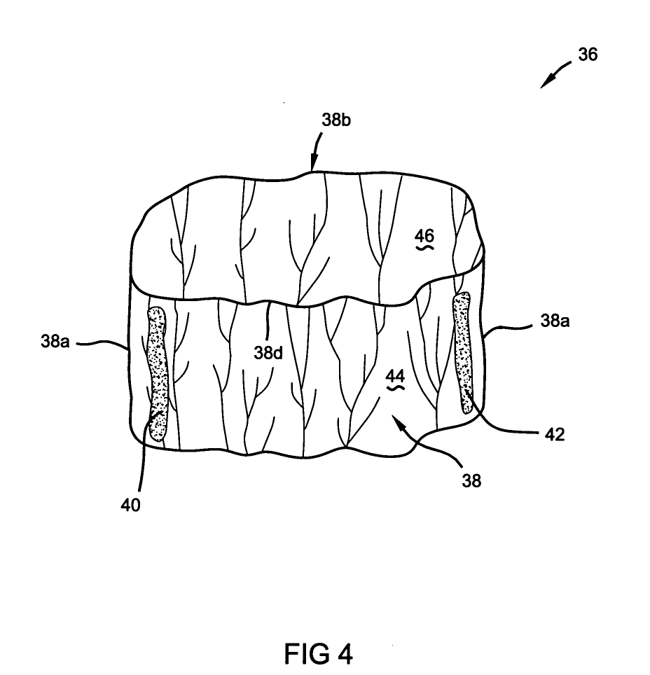

FIG. 4 depicts another alternative embodiment of an edible food container 36. The edible food container 36 includes an edible member 38, a first quantity of edible adhesive 40, and a second quantity of edible adhesive 42. In an exemplary embodiment, the edible member 38 includes a single vegetable leaf, similar to the edible members 12, 28 described above with the exception of having a slightly different geometry. The edible member 38 includes a first edge 38a, a second edge 38b, a third edge 38d, a fourth edge 38d, a handling face 44, and a storage face 46. While the edible member 38 is disclosed herein as having four edges, an edible member 38 having more or less than four edges is intended to be within the scope of the present invention. The first quantity of edible adhesive 40 is disposed on the storage face 46 generally adjacent to the first edge 38a of the edible member 38. The second quantity of edible adhesive 42 is disposed on the storage face 46 generally adjacent to the third edge 38c of the edible member 38. The edible member 38 is folded generally perpendicular to a mid-section of the first and third edges 38a, 38c to form a pocket that defines the container 36. It should be appreciated that in an alternative embodiment, the container 36 also includes insulators 34 similar to those described above with reference to FIG. 3.

Referring back to FIGS. 1 and 2, a method of manufacturing an edible food container 10 in accordance with the first embodiment is described. It should be appreciated that a similar method can be utilized to manufacture an edible food container 26 in accordance with the second embodiment. Initially, the edible members 12 are selected. This may include peeling the members 12 from a head of lettuce, cabbage, or other vegetable, or simply retrieving the members from a storage container. Next, the first quantity of adhesive 14a is applied to the storage face 16 of member 12b. The first quantity of edible adhesive 14a is applied generally adjacent to the second 22 and third 24 edges of member 12b. Next, the second quantity of edible adhesive 14b is applied to the storage face 16 of member 12d. The second quantity of edible adhesive 14b is applied generally adjacent to the second 22 and third 24 edges of member 12d. It is envisioned that the edible adhesive 14 may be applied to the members 12b, 12d with a brush, a roller, a spray can, or any other device. It should also be appreciated that the adhesive 14 is applied generally uniformly across the respective portions of the members 12b, 12d. This provides for a generally constant seal between the members 12 when adhered together. The uniform seal decreases the potential for juice or condiments to leak through the container 10.

Once the adhesive 14 is applied, edible members 12a and 12c are attached to members 12b and 12d to form the container 10, as illustrated in FIG. 1. Then, a meal such as a hamburger, as well as any condiments and/or toppings, are inserted into the container 10 and served to a consumer.

The second embodiment described above and illustrated in FIG. 3, however, requires additional steps. The additional steps include applying the second edible adhesive 32 to the storage face 16 of each of the members 28. Next, the plurality of insulators 34 are attached to the members 28 via the second edible adhesive 32. It is envisioned that these additional steps may be taken prior to or immediately subsequent to attaching the members 28 to form the container 26.

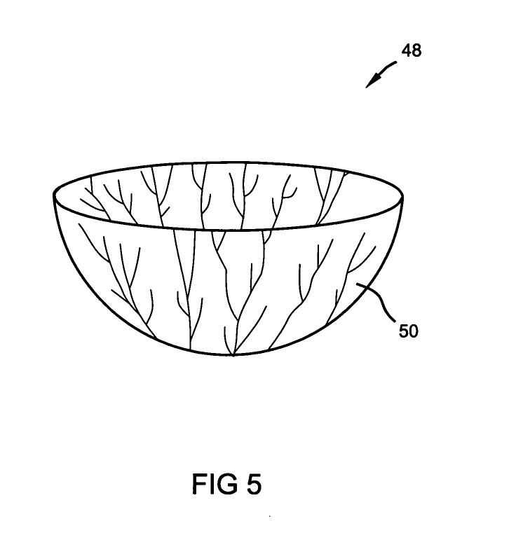

FIG. 5 depicts yet another alternative embodiment of an edible food container 48. The edible food container 48 includes an edible member 50 substantially coated in a shape retaining substance (not shown). In an exemplary embodiment, the edible member 50 includes a single vegetable leaf, similar to edible members 12, 28 and 38 described above. It is envisioned that the edible member 50 may also include, however, a plurality of vegetable leaves. The plurality of vegetable leaves would be held together via the shape retaining substance. The shape retaining substance is an edible adhesive such as the sugar-based or gelatin-based adhesives discussed above. In an alternative embodiment, the shape retaining substance is a thermo-set substance such as liquid gelatin. The liquid gelatin must then be cooled and stored at a temperature below a critical temperature to retain the shape of the food container 48. It is envisioned that the shape retaining substance may also include an added flavoring agent, one or more nutrients, and/or one or more pharmacological compositions. For example, the shape retaining substance may include hot pepper flavoring in combination with an acid-reflux or indigestion medication to preemptively combat heartburn. In an alternative embodiment, the food container 48 further includes insulators 34 similar to those described above with reference to FIG. 3. The insulators 34 may be attached to the edible member 50 via the coating of shape retaining substance or via supplemental quantities of edible adhesive.

During preparation of the food container 48, the edible member 50 is deposited into a mold (not shown). The mold typically includes a female portion and a male portion mating together to define a mold cavity. The mold cavity defines the shape of the food container 48. In an exemplary embodiment, the food container takes the shape of a cup, a bowl, or similar geometry. For example, FIG. 5 depicts the container 48 being shaped similar to half of a pita bread.

The edible member 50 is deposited into the female portion of the mold. The male portion is then placed into the female portion to define the shape of the edible member 50. With the edible member 50 disposed within the mold cavity, the shape retaining substance is injected or poured into the mold cavity. The shape retaining substance substantially coats the edible member 50. In the embodiment wherein the shape retaining substance includes an edible adhesive, the edible adhesive is allowed to cure. In the embodiment wherein the shape retaining substance is a thermo-set liquid gelatin, the mold and substance must be refrigerated to form the container 48. Nevertheless, once the coating solidifies, the container 48 is prepared to contain a meal such as a burger or a hot dog.

The description of the invention is merely exemplary in nature and, thus, variations that do not depart from the gist of the invention are intended to be within the scope of the invention. Such variations are not to be regarded as a departure from the spirit and scope of the invention.

1. An edible food container, comprising:
a first edible member;
a second edible member; and
a first quantity of an edible adhesive disposed between and sealingly attaching said first and second edible members.

2. The food container of claim 1 wherein said first and second members are cup-shaped.

3. The food container of claim 1 further comprising an edible insulator lining a portion of at least one of said first and second members.

4. The food container of claim 3 further comprising a second quantity of said edible adhesive disposed between and attaching said insulator and at least one of said first and second members.

5. The food container of claim 3 wherein said insulator includes at least one of a vegetable and a fruit.

6. The food container of claim 1 wherein said first and second members have a low carbohydrate content.

7. The food container of claim 1 wherein said first and second members include vegetable leaves.

8. The food container of claim 1 wherein said edible adhesive is a sugar based adhesive.

9. An edible food container, comprising:
a first edible member having a storage face and a handling face;
a second edible member having a storage face and a handling face, wherein a portion of said handling face of said second member is disposed adjacent a portion of said storage face of said first member; and
a first quantity of an edible adhesive disposed between and sealingly attaching said first and second members.

10. The food container of claim 8 wherein said first and second members are cup-shaped.

11. The food container of claim 8 further comprising an insulator lining a portion of said storage face of at least one of said first and second members.

12. The food container of claim 11 further comprising a second quantity of said edible adhesive disposed between and attaching said insulator and said storage face of at least one of said first and second members.

13. The food container of claim 11 wherein said insulator includes at least one of a vegetable and a fruit.

14. The food container of claim 9 wherein said first and second members have a low carbohydrate content.

15. The food container of claim 9 wherein said first and second members include vegetable leaves.

16. The food container of claim 9 wherein said edible adhesive is a sugar based adhesive.

17. An edible food container, comprising:
an edible member;
a first quantity of edible adhesive disposed adjacent a first edge of said edible member; and
a second quantity of edible adhesive disposed adjacent a second edge of said edible member, wherein said edible member is folded to form a pocket and said first and second quantities of edible adhesive seal said pocket.

18. The food container of claim 17 wherein said first edge is opposite said second edge.

19. The food container of claim 17 wherein said edible member has a low carbohydrate content.

20. A method of manufacturing an edible food container, comprising:
selecting a first edible member having a storage face and a handling face;
selecting a second edible member having a storage face and a handling face;
applying a first quantity of an edible adhesive to a portion of at least one of said handling face of said second member and said storage face of said first member; and
attaching said first and second members via said first quantity of said adhesive.

21. The method of claim 20 further comprising:
selecting an insulator;
applying a second quantity of said adhesive to at least one of said storage face of said first member, said storage face of said second member, and said insulator; and
attaching said insulator to at least one of said first and second members via said second quantity of said adhesive.

22. An edible food container, comprising:
an edible member; and
an edible substance substantially coating said edible member to retain said edible member in a pre-determined shape.

23. The food container of claim 22 wherein said predetermined shape is substantially cup-shaped.
